(19) United States
(12) Patent Application Publication
(10) Pub. No.: US 2025/0377947 A1
(43) Pub. Date: Dec. 11, 2025

(54) RESOURCE OPTIMIZATION FOR CLOUD COMPUTING ENVIRONMENTS

(71) Applicant: DISH Network Technologies India Private Limited, Bengaluru (IN)

(72) Inventors: Sridhar Chilla, Bangalore (IN); Praveen Kumar Nadipi Karunakara, Bangalore (IN); Yogesh Malhotra, Bangalore (IN); Vedam Jude Pragash, Bangalore (IN); Pardeep Soni, Bengaluru (IN)

(21) Appl. No.: 18/734,676

(22) Filed: Jun. 5, 2024

(51) Int. Cl. G06F 9/50; G06F 9/48

(52) U.S. Cl. CPC G06F 9/5033; G06F 9/4881

(57) ABSTRACT

Systems, devices, and methods related to managing cloud compute instances are provided. An example method includes: receiving a request for performing a compute task on a cloud computing platform, from a user associated with the customer account, identifying a predetermined class for the compute task based on one or more features of the compute task, identifying one or more classes of compute instances correlating to the compute task, based on a predetermined correlation rule, performing a cost optimization process to determine one or more compute instances from one class of the identified classes for the requested compute task, the one or more compute instances having a lowest total cost among the compute instances of the identified classes, and determining availability of the compute instances having the lowest total cost on the cloud computing platform.

### BACKGROUND

Cloud computing platforms providers (i.e., cloud providers) provides their customers with various cost-saving opportunities for optimizing compute resource usage and reducing operational expenses. However, existing cost optimization mechanisms, such as Service Control Policies (SCPs) provided by the cloud providers, have limitations in codifying conditional/threshold-based rules for cost optimization. Furthermore, cloud providers typically define pricing models at the service level but do not provide user-specific and/or application-specific resource optimization. As a result, organizational customers face challenges in dynamically adjusting resource utilization. For example, enterprise customers generally sign up for a low-price offer relating to cloud services, with cloud service provider, in exchange for commitment to a consistent amount of hourly usage of compute resources. If resource allocation is not orchestrated by profile, the resource allocation at the peak time might exceed the committed usage and any usage beyond the commitment will be charged at higher price. On the contrary, allocation of resources during the off-peak time is usually low, and enterprise customers still have to pay for committed usage without actually using the resources.

### SUMMARY

In accordance with some embodiments of the present disclosure, a method is provided. The method may be a computer-implemented method. In one example, a method includes: receiving a request for performing a compute task on a cloud computing platform, from a user associated with the customer account, identifying a predetermined class for the compute task based on one or more features of the compute task, determining if the compute task is a batch job, determining if the compute task can be rescheduled, identifying one or more classes of compute instances correlating to the compute task, based on a predetermined mapping/correlation rule, performing a cost optimization process to determine one or more compute instances from one class of the identified classes for the requested compute task, the one or more compute instances having a lowest total cost among the compute instances of the identified classes, and determining availability of the compute instances having the lowest total cost on the cloud computing platform.

In accordance with some embodiments of the present disclosure, a computer device or computer system is provided. In one example, the computer device or computer system includes: one or more processors and a computer-readable storage media storing computer-executable instructions. The computer-executable instructions, when executed by the one or more processors, cause the computer device or computer system to perform a method described in the present disclosure.

In accordance with some embodiments, the present disclosure also provides a non-transitory machine-readable storage medium encoded with instructions, the instructions executable to cause one or more electronic processors of a computer system or computer device to perform any one of the methods described in the present disclosure.

### BRIEF DESCRIPTION OF THE DRAWINGS

FIG. 1 is a block diagram illustrating an example cloud computing platform, according to various embodiments in the present disclosure.

FIG. 2 is a block diagram illustrating another example of a cloud computing platform, according to various embodiments.

FIG. 3 is a block diagram illustrating an example of a communications system, according to various embodiments.

FIG. 4 illustrates an example classification data table of a class of compute instances, according to various embodiments of the present disclosure.

FIG. 5 is a block diagram illustrating an example of the cost analysis device or module of FIG. 3, according to various embodiments of the present disclosure.

FIGS. 6A-6C are flow diagrams illustrating example methods and processes, according to various embodiments of the present disclosure.

FIG. 7 illustrates an example computer system or computer device, according to various embodiments of the present disclosure.

### DETAILED DESCRIPTION

### Overview

The present disclosure provides systems, devices, and methods generally related to allocation, utilization, optimization, and management of cloud compute resources.

As mentioned above, cloud providers supply time-shared computing, network, storage, and associated technology resources. These resources are commonly known as "cloud compute instances", which are available from various cloud providers including, for example, Amazon's AWS, Microsoft Azure, and Rackspace Cloud. Compute resources from these providers can be made available as "on-demand" resources and often at fixed prices. Additionally, some on-demand resources are allocated to individual customers under contract or agreement at predetermined prices to ensure dedicated access to the resources as per the terms of the agreement. Alternatively, cloud providers may offer "spot" instances, which are available at significantly lower costs compared to on-demand resources. Spot instances allow customers to bid for unused capacity, enabling them to access computing resources at discounted rates.

Both on-demand and spot resources offered by cloud providers can be tiered at different prices based on various characteristics and types of the resources. This tiered pricing model allows cloud providers to offer a range of options to cater to different customer needs and preferences. For example, within the on-demand category, cloud providers may offer different tiers of compute instances based on factors such as CPU, memory, storage capacity, and network performance. Each tier may come with its own pricing structure to allow customers to choose the instance type that best suits their requirements and budget. Similarly, spot instances may also be tiered based on factors such as instance type, availability zone, and demand-supply dynamics. Customers may have the option to bid for different tiers of spot instances, with each tier priced accordingly based on factors like availability, capacity, and performance characteristics.

However, many pricing structures provided by cloud providers are static and fixed, for example, providing a set rate for specific services or resources over a defined period. These fixed pricing models simplify cost estimation and budgeting for customers. However, static pricing structures may not always be the most cost-effective option for customers, especially when workload demands fluctuate or when users require different levels of resources at different times. In such cases, a fixed pricing model may result in underutilization of resources during periods of low demand or overspending during peak periods.

Moreover, many customers of cloud providers are organizational account customers, such as enterprise customers, with multiple internal users associated with their accounts. These internal users, often belonging to various development teams or departments within the organization, may have diverse compute tasks and resource requirements. However, when a user associated with a customer requests cloud resources, the cloud provider typically considers only the account of the customer and does not take into account the specific tasks, services, or user-specific information in optimizing and allocating the resources for the user. As a result, organizations may incur higher-than-needed costs for cloud resources, especially when there are a significant number of internal users with varying resource demands.

The present disclosure provides solutions to the above-mentioned challenges. One insight provided in the present disclosure is related to a customer account management system or device, which serves as a centralized platform for the customer to optimize the distribution, allocation, and utilization of compute resources for its internal users. According to some embodiments, the customer account management system is capable of performing a streamlined process for managing compute instances for its users. In one example, the streamlined process includes classifying the compute tasks requested by the users, determining one or more features/attributes/characteristics associated with the compute task, classifying the various compute instances provided by the cloud computing platform based on one or more features/attributes/characteristics associated with the compute instance, classifying/identifying a batch of compute tasks, determining whether a given compute task is a batch job, determining whether a given compute task can be rescheduled, establishing a set of rules or correlation maps between the class of compute tasks and the class of compute instances according to predetermined cost policies applicable to its users, and optimizing the total cost for a given compute task requested by a user based on the established rules.

The streamlined process described herein offers several advantages over conventional methods that are not user-specific or task-specific. By classifying compute tasks and instances based on their unique features/attributes/characteristics, specific user needs, and specific task requirements, the streamlined process can optimize resource allocation to minimize costs. Comparatively, conventional methods may allocate resources indiscriminately, leading to over-provisioning or under-utilization, which can result in unnecessary expenses. Through the establishment of rules or correlations between the class of compute task and the class of compute instance, the streamlined process can improve the overall resource utilization and the efficiency of the computing environment. The streamline process also allows for customization based on user requirements and priorities by taking into account various factors such as task priority, urgency, and resource needs. As a result, the streamline process guarantees that the critical tasks receive appropriate resources while the non-critical tasks do not overspend.

For example, the streamlined process according to the present disclosure can be implemented to ensure that critical tasks are prioritized during peak times to receive the necessary resources for optimal performance. On the other hand, the present process allows to shift the non-critical batch of compute tasks to the pre-determined off-peak times to make full use of available resources when demand is lower, which can lead to better overall resource utilization. The present process also allows to maintain resource usage at or below the committed level to avoid overage charges. By effectively scheduling compute tasks, enterprise customers can stay within their pre-committed resource limits. If the committed threshold utilization approaches 100% consistently (i.e., across the peak times and the off-peak times), additional commitment-based resources may be scheduled or allocated, such that resources are always available without sudden cost spikes.

### Example Systems, Devices, and Methods

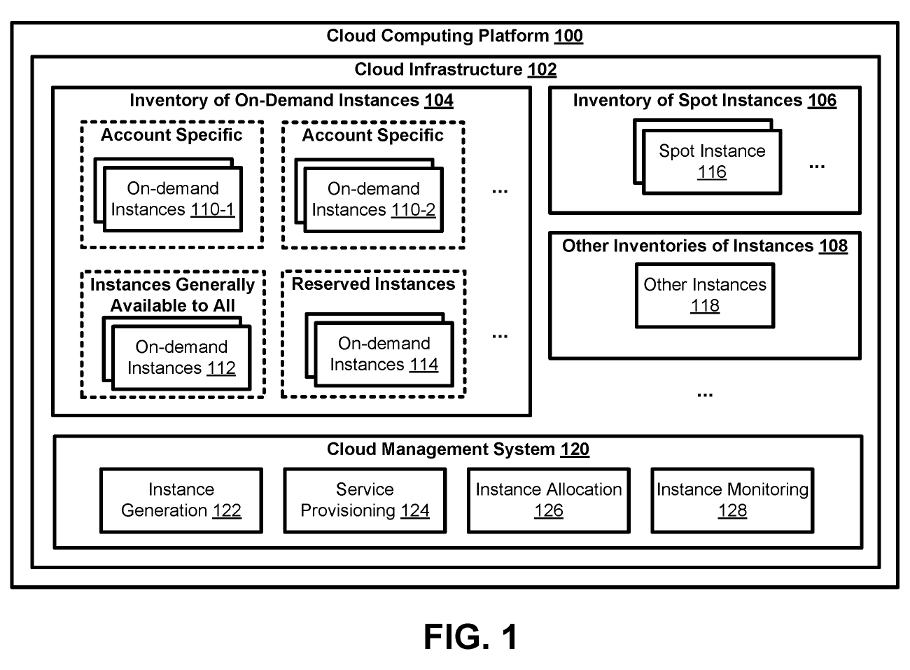

FIG. 1 is a block diagram illustrating an example cloud computing platform 100 (hereinafter "cloud platform 100") according to various embodiments in the present disclosure. The cloud platform 100 is operated by a cloud provide that provides various cloud services and compute instances to customers. In the illustrated example, the cloud platform 100 includes, among other components, cloud infrastructure 102 and cloud management system 120. Additional or few components may be included in the cloud platform 100. Example of the cloud provider include but are not limited to Amazon (Amazon Web Services such as EC2, S3, etc.), Google Compute Platform, or Microsoft (Azure), internal providers operated as private clouds or data centers within large organizations, one or more data centers, distinguished by location, power availability, or other organizational units within other providers, and virtual providers who assemble and make resources from a group of providers available.

Cloud infrastructure 102 includes physical components and resources (e.g., physical servers of data centers) provided by the cloud provider to support the deployment, management, and execution of cloud-based applications and services. Cloud infrastructure 102 provides compute resources such as virtual machines (VMs), containers, and other compute instances that provide processing power for performing compute tasks, executing services, applications, and workloads. Cloud infrastructure 102 further provides scalable storage resources such as object storage, block storage, file storage, and archival storage, network resources that enable connectivity between different components and resources within the cloud platform 100, as well as connectivity to external networks and the Internet.

The cloud infrastructure 102 provides the customers with various compute instances. The compute instances are virtualized compute resources that provides processing power, memory, and storage capabilities within the cloud infrastructure 102. The compute instances can be provisioned to the customers to execute their applications and workloads in the cloud environment. In some embodiments, the cloud infrastructure 102 includes various inventories of compute instances that are categorized by the cloud provider, including inventory of on-demand instances 104, inventory of spot instances 106, and other inventories of instances 108.

The inventory of on-demand compute instances 104 may further include on-demand compute instances that are specific to a customer or an account (e.g., account specific compute instances 110-1, account specific compute instances 110-2, etc.), on-demand compute instances generally available to all customers or accounts (e.g., general on-demand compute instances 112), and reserved on-demand compute instances 114. Compute instances 110 (e.g., 110-1, 110-2, etc.) are specifically committed to or reserved for a particular customer account. Each customer account may have its own dedicated pool of instances that are reserved for its exclusive use. General on-demand compute instances 112 are available to all customers or accounts on a first-come, first-served basis, not reserved or dedicated to any specific customer. Customers can dynamically launch the instances 112 as needed and pay for the usage based on the duration and resources consumed. Reserved on-demand compute instances 114 are compute instances that customers commit to using for a specified term in exchange for discounted pricing compared to standard on-demand instances. Customers can reserve capacity in advance to ensure availability and secure cost savings for predictable workloads or steady-state applications.

The inventory of spot instances 106 includes spot instances 106. Spot instances 106 allow customers to bid on unused compute resources of the cloud platform 100 at reduced prices compared to standard on-demand instances. The spot instances 106 are part of the spot market, where prices can fluctuate based on supply and demand dynamics. The price of spot instances 106 may vary over time based on factors such as supply and demand, instance type, instance features, availability zone, and related cloud services. Customers can bid for spot instances 106 at the price they are willing to pay, and spot instances are allocated to the highest bidders until the spot price exceeds their bid. However, spot instances 106 may be subject to termination or preemption, commonly referred to as "spot instance interruption." When a spot instance 106 is interrupted, the spot instance 106 is terminated (or deallocated) by the cloud management system 120, and any running workloads on the spot instance 106 are stopped.

Other inventories of instances 108 includes other instances 118. Other instances 118 include additional types or categories of compute instances that may be provided by the cloud provider but are not specifically categorized as on-demand or spot instances. The other instances 118 could include specialized instance types optimized for specific use cases, such as high-performance computing (HPC), machine learning (ML), graphics processing, memory-intensive applications, or storage-optimized workloads.

The cloud management system 120 includes, among other components, instance generation component 122, service provisioning component 124, instance allocation component 126, and instance monitoring component 128. Each component may be a hardware component such as a device or an engine or a module, a software component such as an application, a service, a cloud-native service, or a combination of hardware and software for performing the specific functions, depending on the specific implementation and architecture of the cloud management system 120.

The instance generation component 122 is generally responsible for generating compute instances within the cloud infrastructure 102, provisioning virtual machines, containers, or other types of compute resources, predefined templates, and automation policies. Various virtualization techniques may be implemented by the instance generation component 122 to virtualize the physical resources and generate compute instances. In one example, the instance generation component 122 may be configured to allocate a physical server within a data center of the cloud infrastructure 102, execute a hypervisor on the selected physical server to create a virtual machine (VM) on the allocated physical server, allocate virtual CPU, memory, storage, and network adapters to the VM, monitor the resource usage of the VM, isolate the VM from other VMs on the physical server, and perform auto-scaling and other services as needed.

In another example, containerization is implemented to generate compute instances (e.g., nodes) within a container orchestration cluster (e.g., Kubernetes cluster). The instance generation component 122 may be configured to provide a container orchestration cluster on a cloud platform, generate nodes within the container orchestration cluster, wherein each node represents a compute instance capable of running containerized workloads using container runtimes, configure the nodes manage the allocation and scheduling of containerized workloads across the nodes within the container orchestration cluster. Once nodes are allocated to a customer or an account user within the container orchestration cluster, the applications or cloud services can be deployed by the users on those nodes. In Kubernetes, applications are typically deployed using pods, which are the smallest deployable unit and represent one or more containers that share resources and networking. It should be noted that the above examples of the virtualization techniques are for illustrative purposes only and are not intended to limit the scope of the present disclosure.

The service provisioning component 124 is generally responsible for provisioning requested cloud services to users upon receiving user requests. In some embodiments, the service provisioning component 124 is configured to identify the specific cloud service requested by the user, generate and configure an isolated cloud environment tailored to the user's requirements and specifications, determine the user-specific applications or compute tasks that will be deployed within the allocated cloud environment, and facilitate user access to the provisioned cloud environment to allow the user to execute the applications and perform compute tasks. In some embodiments, the cloud environment is a personal cloud on AWS. Examples of the cloud services on AWS include but are not limited to Elastic Compute Cloud (EC2), Simple Storage Service (S3), Relational Database Service (RDS), Elastic Container Service (ECS), Elastic Kubernetes Service (EKS), Elastic Container Service (ECS), Elastic Kubernetes Service (EKS), Simple Queue Service (SQS), Elastic In-memory Caching Service (e.g., ElastiCache), and so on.

The instance allocation component 126 is generally responsible for allocating compute instances to the cloud environment established for the user to support execution of the applications and performing compute tasks in the cloud environment. In some embodiments, the instance allocation component 126 is configured to identify the compute instances indicated in the user request or required by the user, identify the inventory that provides the required compute instances, determine the availability of the compute instances in the inventory, and allocate the selected compute instances from the inventory to the cloud environment associated with the user.

The instance monitoring component 128 is generally responsible for monitoring the real-time usage of the allocated instances for each customer or account, a total usage of the compute instances for each inventory, and an availability level of each inventory of instances. In some embodiments, the instance monitoring component 128 may generate real-time usage data of the compute instances and transmit the real-time usage data to the customer upon request. In some embodiments, cloud-native tools such as Cloud Trial provided by AWS can be employed by the customer account management system to monitor the real-time usage of the compute instances (i.e., on-demand compute instances and spot instances) within the customer account.

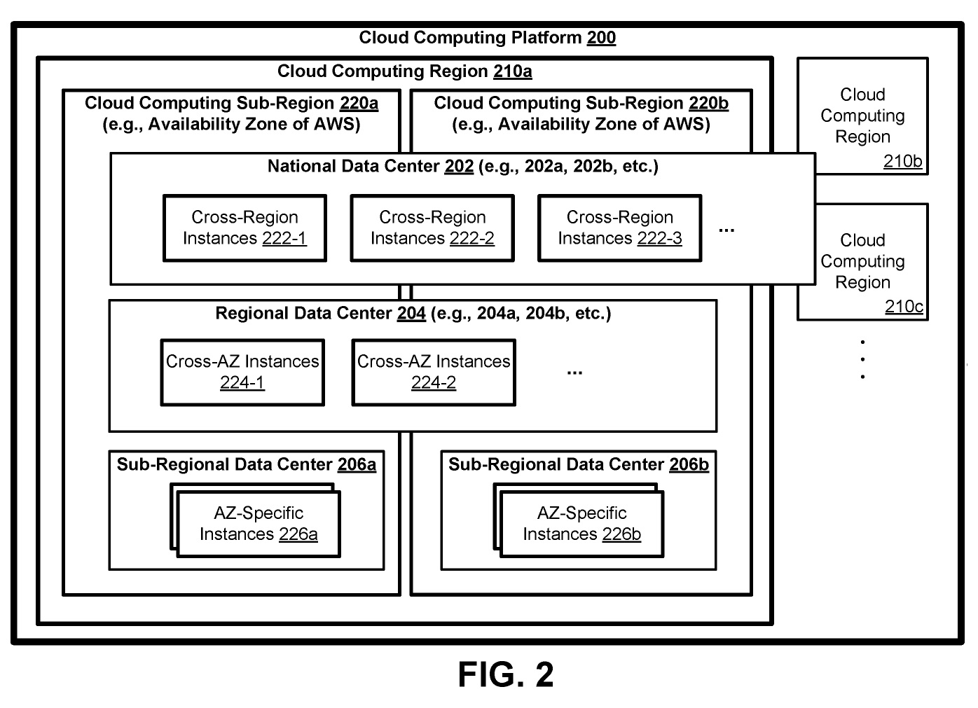

FIG. 2 is a block diagram illustrating another example of a cloud computing platform 200, according to various embodiments. Cloud computing platform 200 can be logically and physically divided up into various different cloud computing regions 210 (e.g., a first cloud computing region 210a, a second cloud computing region 210b, a third cloud computing region 210c, … etc.). For the purpose of simplicity, the cloud computing region is used interchangeably with "region." Each one of the cloud computing regions 210 can be isolated from other cloud computing regions to help provide fault tolerance and stability. Further, each of cloud computing regions 210 may provide superior service to a particular geographic region based on physical proximity. For example, cloud computing region 210a may have its datacenters and hardware located in the northeast of the United States while cloud computing region may have its datacenters and hardware located in California. For simplicity, the details of the cellular network as executed in only cloud computing region 210a is illustrated. Similar components may be executed in other cloud computing regions of cloud computing regions 210 (210b, 210c, … etc.).

Each of cloud computing regions 210 may include two or more cloud computing sub-regions 220 (e.g., 220a1, 220a2, … etc.). Each of cloud computing sub-regions 220 can allow for redundancy that allows for fail-over protection. Such as, if a particular cloud computing sub-region experiences an outage, another cloud computing sub-region within the same cloud computing region can continue functioning and providing service. If the cloud computing platform used is AWS platform, cloud computing sub-regions may be also referred to as and used interchangeably with "sub-region," "availability zones," or "AZ." For example, a database that is maintained as part of national data center (NDC) 202 may be established across the cloud computing sub-regions 220 or replicated in each cloud computing sub-region 220; therefore, if one of cloud computing sub-regions 220 fail, a copy of the database remains up-to-date and available, thus allowing for continuous or near continuous functionality.

NDC 202 can be further understood as having its functionality existing in multiple (e.g., two, three, or more) cloud computing sub-regions 220 and across multiple cloud computing regions 210 (e.g., across regions 210a, 210b, and 210c). Thus, the NDC 202 can host multiple cross-region compute instances 222 (e.g., 222-1, 222-2, 222-3, etc.). This arrangement allows for load-balancing, redundancy, and fail-over. Within NDC 202, multiple regional data centers (RDCs) can be logically present, of which a single RDC is illustrated as RDC 204. Each of such one or more RDCs 204 may execute cloud services and applications for a different geographic region. In some embodiments, a single RDC 204 may have its functionality existing in multiple (e.g., two, three, or more) within one cloud computing region 210 (e.g., within the cloud computing region 210a). Thus, the RDC 204 can host multiple cross-AZ compute instances 224 (e.g., 224-1, 224-2, etc.), which are executed across multiple cloud computing sub-regions 220 for redundancy, processing load-balancing, and fail-over.

Sub-regional data center (SRDC) 206 has its functionality existing in a single cloud computing sub-region or AZ 220 and can only host AZ-specific compute instances 226. For example, the SRDC 206a can only host compute instances 226a that are specific to AZ 220a; the SRDC 206b can only host compute instances 226b that are specific to AZ 220a. This arrangement allows that compute resources are deployed within the same geographic area for low-latency and high-availability purposes.

The various compute instances illustrated in FIGS. 1-2 are provided by the cloud provider at different unit prices (e.g., price per hour). For example, the account specific compute instances committed to a customer account are typically provided at discounted prices under contractual agreements between the customer and the cloud provider or as part of a cost-saving plan. The unit price for these instances may be fixed or subject to predetermined discounts based on the terms of the agreement. The general on-demand instances are available at higher unit prices without any specific discounts. However, the supply of on-demand instances is typically guaranteed once allocated to the customer to ensure availability when needed. The spot instances are typically provided at a fluctuating unit price, closely depending on market demand. The cloud provider may adjust the unit price in response to market changes, and the price may increase when demand exceeds supply. For example, spot instance may be initially provided at $1/hour for the first 4 hours. However, when the demand for spot instance on the market increases, the unit price for the spot instance may be increased to $2/hour by the cloud provider in response to the market change. Additionally, spot instances are subject to a predetermined time limit, after which they may be deallocated, killed, or preempted by the cloud provider, as mentioned above.

Other features of the compute instances may include the type (e.g., T-type, M-type, R-type), size (e.g., large, medium, small), regions and data centers, and related cloud services (e.g., cache node in ElastiCache). For example, compute instances optimized for compute-intensive workloads (e.g., R-type instances) may be priced differently from instances optimized for memory-intensive tasks (e.g., M-type instances). T-type instances are generally more cost-effective than fixed-performance instances (e.g., M-type or R-type instances) for workloads with sporadic or bursty CPU usage patterns.

In some embodiments, the unit price for the compute instance also depends on the time of execution. For example, the unit price at peak hours (e.g., predetermined high-demand periods) may be significantly higher than the unit price at off-peak hours (e.g., predetermined low-demand periods) for a specific compute instance. Peak hours typically correspond to times when demand for compute instances is highest. As another example, the unit price may also depend on the total duration of time for which a compute instance is executed. For instance, the unit price for an on-demand compute instance may be set by the cloud provider at $1/hour if the user's demand for time is 24 hours and set at $3/hour if the user's demand for time is 6 hours. As mentioned, the pricing structure for the account-specific on-demand compute instances are predetermined under contractual agreement or specific customer saving plans. However, the pricing structure for the spot instances may be fluctuating and less predictable to the customer.

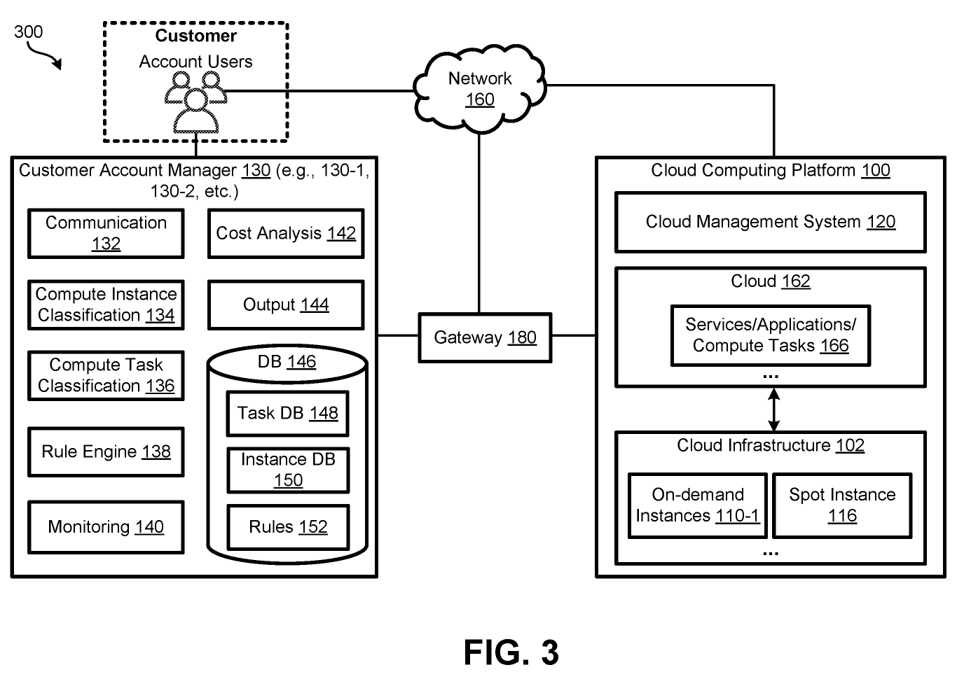

FIG. 3 is a block diagram illustrating an example of a communications system 300, according to various embodiments. In the illustrated example, the communications system 300 includes, among other components, cloud computing platform 100 or 200, customer account management system 130, network 160, and gateway 180. The customer account management system 130 (e.g., 130-1, 130-2, etc.) is a customer-specific centralized platform that allows the customer to independently manage user activities on the cloud computing platform 100 of all users associated with the account.

In some embodiments, the customer account management system 130 further includes, among other components, a communication device or module 132, a compute instance classification device or module 134, a compute task classification device or module 136, a rule engine or module 138, a compute instance monitoring device or module 140, a cost analysis device or module 142, an output device or module 144, and a database 146.

The communication module 132 is responsible for facilitating communication between the customer account management system 130 and the internal users of the customer or associated with the customer account, allowing for exchange of data, message, instruction, request, command, and other information between the individual user and the communication module 132. For example, the communication module 132 can provide an interface for the customer account management system 130 to receive a request for a cloud on the cloud computing platform 100, a request for a cloud service/application/compute task, or a request for compute instances from an account user (via a user computing device). The communication module 132 can provide an interface for the customer account management system 130 to send an output, an instruction, and a command to its users.

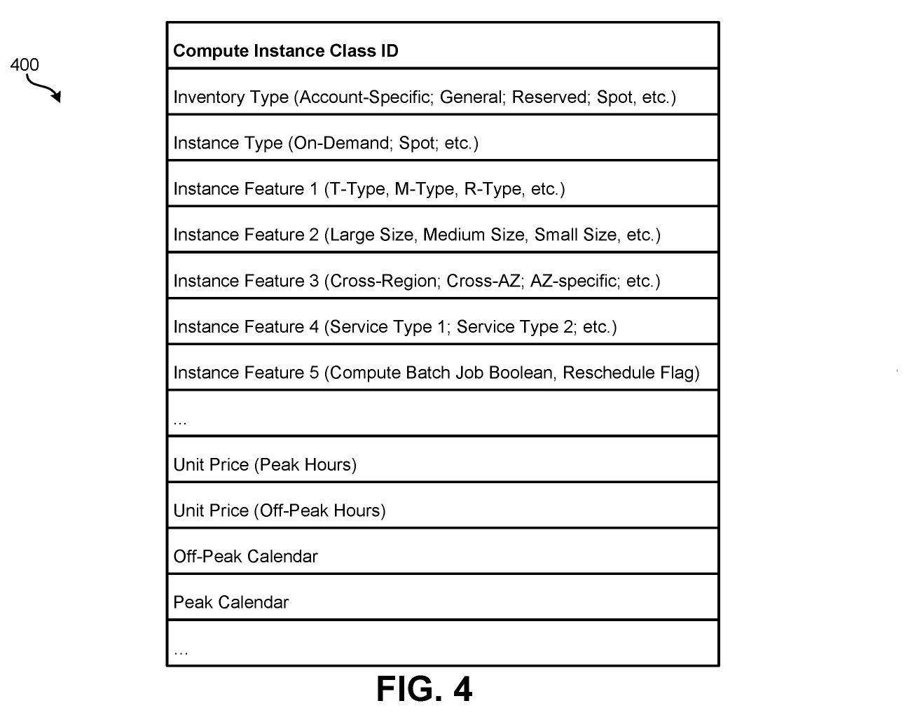

The compute instance classification module 134 is configured to classify and categorize the compute instances provided by the cloud provider, based on various factors such as the inventory type, instance type, instance features/attributes/characteristics, pricing structures (e.g., unit prices), and usage pattern to generate a classification data table. An example of the classification data table 400 is illustrated in FIG. 4. In the illustrated example of FIG. 4, each class of compute instances has an assigned class ID and is characterized by the inventory type, instance type, one or more instance features, as well as unit prices for different time periods and calendars of the peak time and off-peak time. In some embodiments, the compute instance classification module 134 is configured to classify the account-specific on-demand compute instances based on information extracted from a preestablished purchase agreement between the customer and the cloud provider.

In some embodiments, the class ID of a compute instance may include a feature indicating whether the compute task is a batch job or non-batch job. For example, the compute task may be assigned a batch job Boolean value (e.g., true/false) indicating whether a particular compute task is a batch job. The compute task may also be assigned a reschedule flag indicating whether the compute task should be rescheduled. The batch job may indicate that the compute task can be executed in bulk and is typically not time-sensitive nor in high-priority. Batch jobs are scheduled to run during off-peak hours to optimize resource utilization. On the other hand, if the compute task is not a batch job, it requires immediate or timely execution.

In some embodiments, the class ID of a compute instance may include a feature indicating whether the compute task should be rescheduled. For example, the compute task may be assigned a feature indicating a reschedule flag. The reschedule flag indicates whether a compute task should be rescheduled. The reschedule flag may be associated with or dependent on a predetermined priority level of the compute task. A non-urgent or low-priority compute task might be rescheduled to run during off-peak time to avoid peak-time resource contention.

The compute task classification module 136 is configured to classify and categorize the compute tasks within the customer account, based on various factors such as the features/attributes/characteristics of the compute tasks (e.g., criticality/priority/urgency of the compute task), type of cloud services, time duration of the tasks, etc. An example of an urgent compute task (i.e., with a high priority) is a critical customer-facing application that experiences a sudden surge in traffic or service outage. The request for compute task from the user (e.g., an operations team of the customer) indicates an immediate scale up the compute instances in response to the increased load and restore service availability. An example of a normal compute task (i.e., with a low priority) is a routine application executed by a user (e.g., an analytics team of the customer) to process historical user behavior data (e.g., analyzing large datasets, applying machine learning algorithms, and generating reports, etc.), derive insights, and generate personalized recommendations for the users. The normal compute task is considered low priority because it does not involve critical operations or immediate action.

The rule engine 138 is configured to generate various rules. For example, an example rule may specify a correlation between the classification of a compute task and the time of execution. Each compute task is classified based on one or more features or attributes or characteristics, such as priority level (e.g., low priority, medium priority, or high priority). The rule imposes time-based restrictions on when a compute task of a specific priority level can be executed. For instance, a task classified as low priority may only be allowed to run during off-peak hours (times of low demand), but not during peak hours (times of high demand). The rule engine 138 may enforce the restrictions by evaluating the classification of compute tasks and the current time against the defined rules. If a task violates the rules (e.g., attempting to run during peak hours), it may be rejected or queued for execution at a later time when it complies with the rule.

Another example rule may specify a correlation between the classification of the compute tasks and the availability of instances. Each compute task is classified based on one or more features or characteristics. The rule imposes restrictions on when a compute task of a specific feature can be executed based on the availability of the instances. For instance, certain compute tasks, based on one or more features, are restricted to be executed only on account-specific on-demand compute instances when the account-specific on-demand compute instances are available; spot instances, which may be less reliable due to potential interruptions, are not allowed for executing certain tasks. Certain compute tasks may be allowed to be executed on general on-demand compute instances when the account-specific on-demand compute instances are not available. Certain compute tasks may be allowed to be executed on spot compute instances when the on-demand compute instances are not available.

Another example rule may specify a correlation between the classification of the compute instances and the classification of the compute tasks. Each compute task is classified based on one or more features/attributes/characteristics. The rule imposes restrictions on when a compute task of a specific priority level can be executed based on the classification of compute instances. For instance, compute tasks classified as development/testing are only allowed to run on T-type compute instances; M-type and R-type compute instances, which are typically more expensive, are not allowed for compute tasks classified as development/testing. For instance, compute tasks classified as development/testing are only allowed to run on AZ-specific instances (e.g., single RDS instances); cross-region compute instances and cross-AZ compute instances, which are typically more expensive, are not allowed for compute tasks classified as development/testing.

It should be noted that the example rules provided above are for illustrative purposes only. Various rules may be generated by the rule engine 138 to map the correlation between the classification of compute instances with classification of compute tasks. In addition, the rules generated by the rule engine 138 can be combined and applied in various logical and coherent ways to achieve desired outcomes, including creating rule sets, applying rule priorities, or implementing conditional logic to handle complex scenarios.

The cost analysis module 142 is generally responsible for processing/analyzing a request for computing instance (e.g., request for performing a compute task), determining the compute instance for the compute task based on the rules, optimizing total cost for the compute instance based on the features of the computing task and compute instance, and recommend compute instances based on the optimized cost.

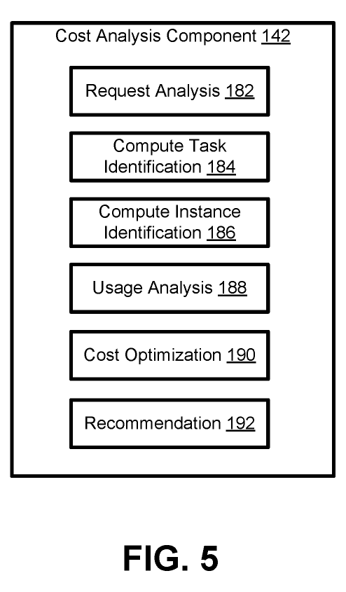

FIG. 5 is a block diagram illustrating an example of the cost analysis module 142, according to various embodiments of the present disclosure. In the illustrated example, the cost analysis module 142 includes, among other components, a request analysis module 182, a compute task identification module 184, a compute instance identification module 186, a usage analysis module 188, a cost optimization module 190, and a recommendation module 192.

The request analysis module 182 is configured to process/analyze a request for compute tasks or compute instances sent from a user associated with the customer or the customer account and received in the customer account management system 130, extract information about the requested compute tasks and determine one or more features/attributes/characteristics of the requested compute task such as the priority level, urgency, type of service, type of application associated with the compute task, etc.

The compute task identification module 184 is configured to categorize the requested compute task into a predetermined class that aligns with its characteristics. The compute task identification module 184 may conduct a comparison between the features of the requested compute task and the standard features associated with each predefined class. Through the comparison process, the compute task identification module 184 can identify the most suitable class for the requested compute task.

The compute instance identification module 186 is configured to identify a class of compute instances that aligns with the compute tasks based on a predetermined set of rules or correlation maps that establish the relationship between the class of compute tasks and the class of compute instances.

The usage analysis module 188 is configured to determine the expected usage of compute instances for the requested compute tasks, such as the expected time of execution, the amount of processing power, the amount of storage (in-memory caching and persistent storage space), etc. The usage analysis module 188 is also configured to analyze the real-time compute instance usage data obtained by the monitoring module 140 and determine a current total usage of compute instance (e.g., account specific on-demand compute instances) within the account. The usage analysis module 188 may derive insights into the overall utilization of compute instances over time by comparing this real-time usage data with historical usage patterns. In some embodiments, the usage analysis module 188 is further configured to estimate the total usage of compute instance within the account for a period of time (e.g., during the time when the requested compute task is performed on the cloud platform). For example, the usage analysis module 188 may be configured to perform in-depth analysis to extrapolate from existing usage trends and consider various factors such as concurrent and upcoming compute tasks and anticipated workload fluctuations to forecast the total compute instance usage for a specified period of time.

The cost optimization module 190 is generally responsible for determining the most cost-effective approach for executing compute tasks on the cloud platform. The cost optimization module 190 is configured to calculate the total cost associated with the compute instances required to complete a given task, based on various parameters such as the class of the compute task, the unit price associated with each compute instance, and the estimated/anticipated duration of compute instance execution. In scenarios where multiple compute instances are necessary for the task, the module calculates the individual cost of each compute instance and aggregates them to determine the total cost. The cost optimization module 190 is further configured to identify the class (or a combination of classes) of compute instances that provide(s) the lowest cost for performing the computing task. For example, the cost optimization module 190 may evaluate multiple classes of compute instances that are suitable for the compute task, compare the cost for each class, and select the most economical option.

The recommendation module 192 is configured to provide a list of options of compute instances for the compute task. The recommendation module 192 may generate a selection of compute instances based on various factors such as cost, availability, and suitability for the compute. The options may be presented in a structured format and arranged from the lowest cost to the highest cost. Additionally, the recommendation module 192 may provide a clear recommendation highlighting the compute instance offering the lowest cost to facilitate informed decision-making.

Now referring back to FIG. 3, the output module 144 is configured to generate an output including the list of options of the class of compute instances for the requested compute task and the recommendation provided by the cost analysis module 142. The output may be presented to the decision maker to approve or disapprove the option of the class of compute instances recommended by the cost analysis module 142.

Upon receiving approval for the compute instances, the customer account management system 130 initiates a request to the cloud management system 120 through the gateway 180. The request serves as a directive to the cloud management system 120 to facilitate the creation of a dedicated cloud environment, denoted as cloud 162, within the cloud computing platform 100. The cloud management system 120 may orchestrate the creation of the designated cloud 162, configure the cloud 162 based on the specified parameters and requirements, allocate the approved compute instances from the available inventory provided by the cloud infrastructure 102. Once the compute instances are allocated to the designated cloud 162, the user is provided with access to the cloud 162 to execute services, deploy applications, and perform compute tasks as needed.

The gateway 180 facilitates communication between the customer account management system 130 and the cloud management system 120 within the cloud computing platform 100. The gateway 180 can be implemented as a software component or service configured to manage the flow of data and requests between the customer account management system 130 and the cloud management system 120. In some embodiments, the gateway 180 is implemented as an application programming interface (API). The API gateway serves as a centralized entry point that enables the users of the customer account management system 130 to interact with various services and resources on the cloud computing platform 100. The API can manage endpoints that expose specific functionalities or services provided by the cloud management system 120. Each endpoint corresponds to a specific API route or operation. When a request is made by the user or the customer account management system 130, the API can route the request to the appropriate backend services or services within the cloud management system 120 based on predefined API routes or paths. The API can handle protocol translation to allow the users to communicate with backend services using different communication protocols or message formats. The API may also provide a pathway for monitoring and tracking (e.g., collection, transformation, and transmission of compute instance usage data).

The communications network 160 communicatively interconnects the various components of communications system 300. The communications network 160 may utilize any known and/or later arising communications and/or networking technologies, standards, protocols or otherwise. Non-limiting examples of such technologies include packet switch and circuit switched communications technologies, such as and without limitation, Wide Area Networks (WAN), such as the Internet, Local Area Networks (LAN), cellular communications networks such as a 3G/4G/5G/6G or other cellular network, Internet of Things (IoT) networks, cloud-based networks, private networks, public networks, or otherwise.

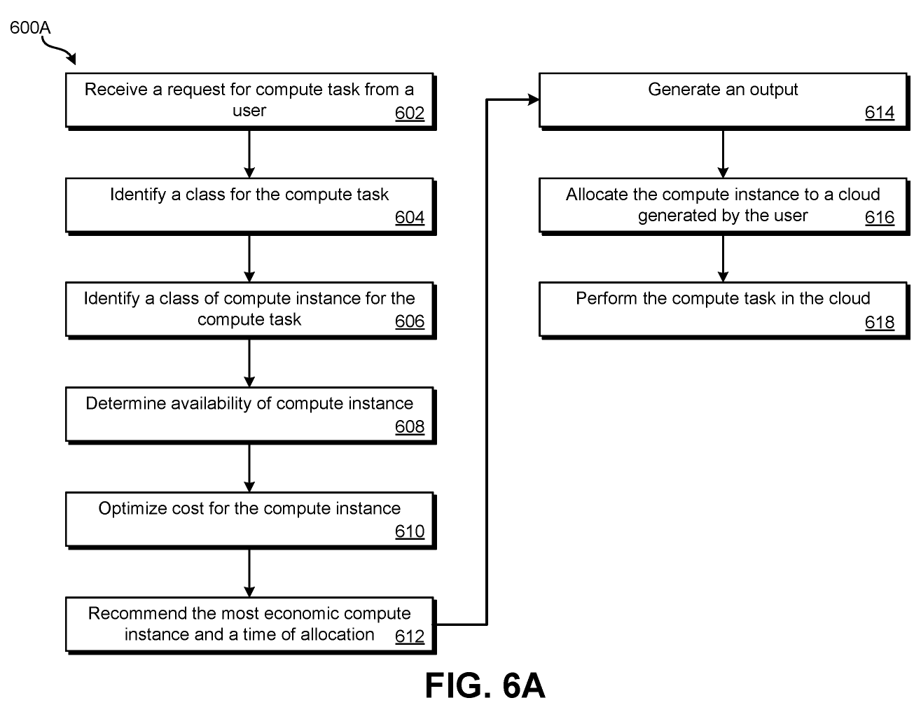

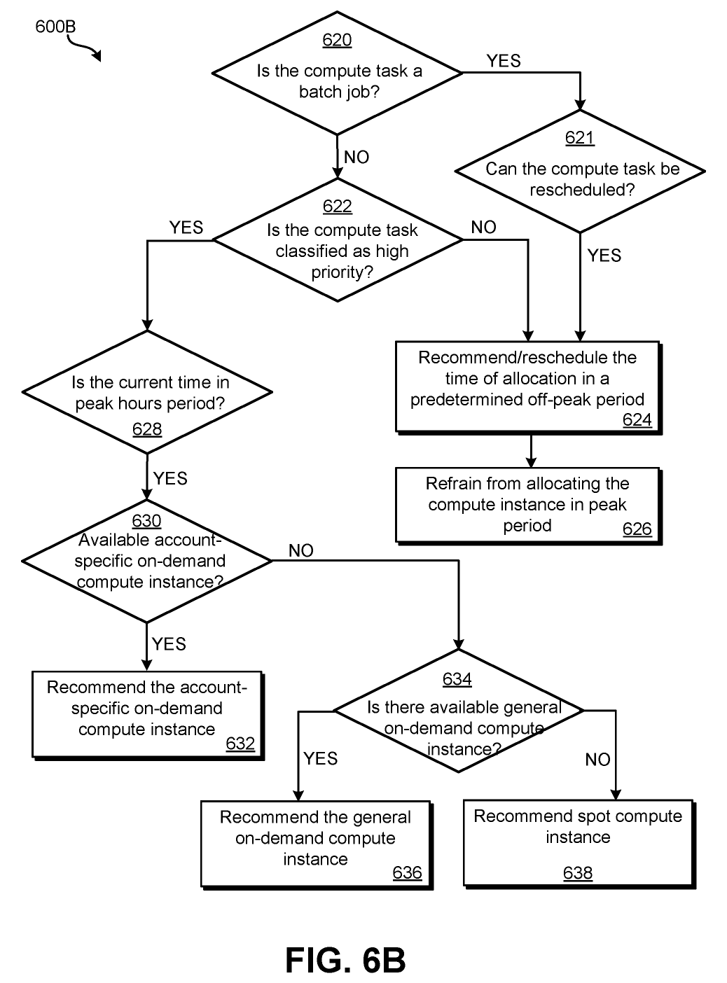

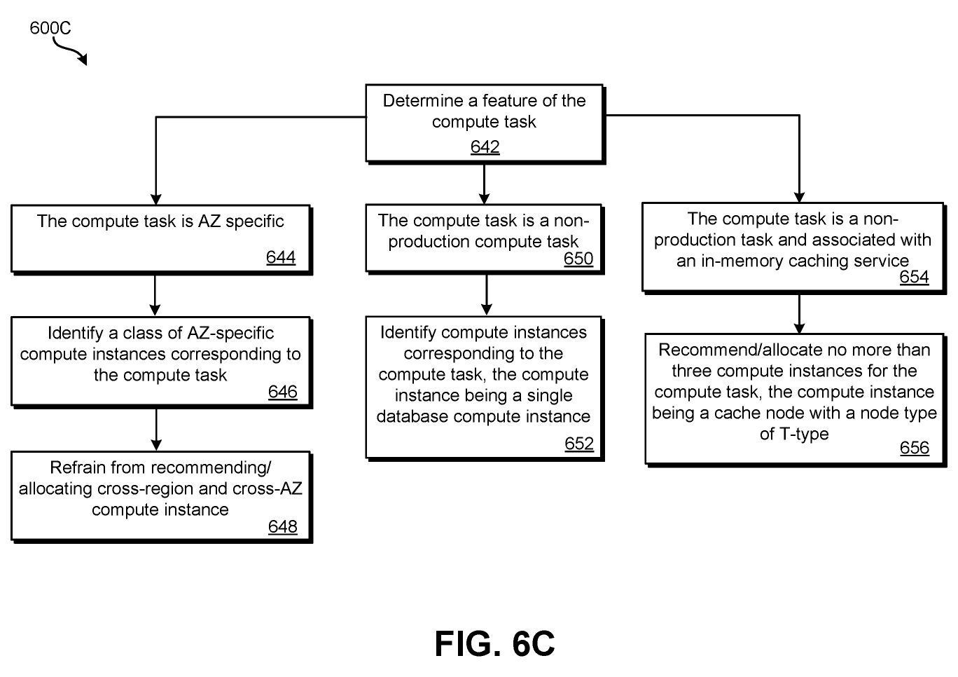

FIGS. 6A-6C are flow diagrams illustrating example methods and processes, according to various embodiments of the present disclosure. The methods and processes may be performed by the communications system 300 or any component thereof, such as the customer account management system 130, the cost analysis module 142, etc. Operations of each method or process may be combined with other methods and processes in any suitable manner.

FIG. 6A illustrates method 600A, which includes operations 602-618. Fewer or additional operations may be included. At 602, a request for compute task is received in the customer account manager. The request is generated by and sent from a user associated with the customer account. The request may include information about the desired compute task, desired cloud service, desired compute instances or resources, and desired execution time, among others.

At 604, a class for the requested compute task is identified by the customer account manager. In some implementations, the request is analyzed to extract various features/attributes/characteristics of the compute task. The extracted features are compared with standard features that are predefined or established based on common characteristics/features of compute tasks for a predefined class. By matching the extracted features with the standard features, a class of compute tasks that aligns with the characteristics of the requested compute task is identified.

At 606, a class of compute instances suitable for the request compute task is identified by the customer account manager, based on predetermined rules specifying the correlation between the class of the compute instances and the class of the compute tasks.

At 608, the availability of compute instances of the class provided by the cloud platform is determined by the customer account manager. This determination may involve various steps, depending on the implementation. In some implementations, real-time compute instance usage data is obtained, which reflects the current utilization of compute instances allocated to the account. This data is used to assess the current availability of compute instances specific to the account by comparing the usage data with the total compute instances allotted to the account. In some implementations, an anticipated usage of compute instances for a predetermined future period (i.e. from the current time to a predetermined future time) is estimated, and the anticipated availability of compute instances during the predetermined future period is determined based on the estimated usage. In some implementations, a determination is made on whether the current or anticipated availability of compute instances meets or exceeds a predefined threshold, either at the current time or over a specified period. The threshold is used as a criterion for determining whether the available compute instances are sufficient to meet the anticipated demand.

At 610, a cost optimization process is performed. The cost optimization process may involve multiple steps, depending on implementations. In some implementations, a cost for each one of the compute instances is calculated based on the unit price of the compute instance and the anticipated time of executing the compute instance for the compute task, and the costs for each compute instance is aggregated to obtain a total cost. When multiple classes of compute instances are suitable for performing the compute task, the total cost for each class of compute instances is calculated and ranked from the lowest to the highest. In some implementations, multiple options of compute instances or a combination of compute instances may be suitable for performing the compute task, and a total cost for each one of the multiple options may be calculated and ranked.

At 612, the most economic compute instance (e.g., the compute instance with the lowest anticipated cost) is recommended by the customer account manager. In some implementations, a time of allocation the economic compute instance (e.g., a current time, an anticipated time in the future, etc.) is also recommended by the customer account management system to allocate the most economic compute instance to the user.

At 614, an output is generated by the customer account manager. The output may include the request for compute task, various analytics data of the compute task, options of compute instances, the anticipated cost associated with each option, as well as the recommendation on the compute instances and the time of allocation. The output is further present to the decision-maker of the customer, and the decision-maker makes a decision on the compute instances for the requested compute task.

At 616, when the compute instance for the compute task and the time of allocation are decided by the decision-maker (e.g., the recommended compute instance is approved by the decision-maker), a request for the compute instance is sent to the cloud platform. In response, a cloud is generated on the cloud platform and configured by the cloud management system, and the requested compute instance is allocated to the cloud at the requested time of allocation. At 618, the compute task is performed on the allocated compute instances within the cloud.

FIG. 6B illustrates an example process 600B for determining/recommending compute instances for the request compute task. In the illustrated example, a determination is made on whether the requested compute task is a batch job by verifying the compute batch job Boolean value as one of the instant features. A true value indicates a batch job, and a false value indicates a non-batch job. In the presence of a true value, the process proceeds to process block 621. In the presence of a false value, the process proceeds to process block 622.

At 621, a determination is made on whether the compute task (a batch job) can be rescheduled. In some embodiments, a determination is made on whether the compute task carries a reschedule flag as one of the instance features. If the compute task has a reschedule flag, the compute task can be rescheduled to an off-peak period that has been predetermined. If the compute task has no reschedule flag, the compute task cannot be rescheduled to an off-peak period. If the compute task can be rescheduled, the process proceeds to from process block 621 to process block 624. At 624, a recommendation is made to reschedule the compute task and allocate the compute instances at a time in a predetermined off-peak period or low-demand period.

At 622, when the requested compute task is not classified as a batch job, a determination is made on whether the requested compute task is identified to belong to a class of high priority compute tasks, based on the features/attributes/characteristics of the compute task extracted from the request.

At 624, based on a determination that the requested compute task does not belong to the class of high-priority compute tasks, a recommendation is made to allocate the compute instances at a time in a predetermined off-peak hour period or low-demand period. At 626, allocation of compute instances in the predetermined peak period or high-demand period is prevented or prohibited.

On the other hand, based on a determination that the requested compute task belongs to the class of high-priority compute tasks, a determination is made, at 628, on whether the current time is in the predetermined peak hour period or high-demand period. At 630, based on the determination that the current time is in the predetermined peak hour period, a determination is made on whether there is an available account-specific on-demand compute instance corresponding/correlating to the compute task within the account.

At 632, based on the determination that there is an available account-specific on-demand compute instance within the account, recommend the account-specific on-demand compute instance for the compute task. The account-specific on-demand compute instance may be allocated to the user immediately according to the recommendation.

On the other hand, based on the determination that there is no available account-specific on-demand compute instance within the account, a determination is made, at 634, on whether there is available general on-demand compute instance on the cloud platform. At 636, based on the determination that there is available general on-demand compute instance on the cloud platform, recommend the general on-demand compute instance for the requested compute task. On the other hand, based on the determination that there is no available general on-demand compute instance on the cloud platform, recommend, at 638, spot compute instance on the cloud platform for the requested compute task.

FIG. 6C illustrates another example process for determining/recommending compute instances for the request compute task. In the illustrated example, one or more features/attributes/characteristics of the compute task are determined at 622. At 644, the compute task is determined to be an AZ-specific compute task and only needs AZ-specific compute instances. At 646, a class of AZ-specific compute instances corresponding/correlating to the compute task is identified based on the predetermined rules or correlation map. At 648, the AZ-specific compute instances are recommended for the compute task and allocated to the user. Recommendation and allocation of cross-region and cross-AZ compute instances are prevented or prohibited.

At 650, the compute task is determined to be a development/testing task (i.e., non-production task). In other words, performing the compute task only requires a development/testing environment on the cloud platform (i.e., a non-production or lower-level cloud environment on the cloud platform). At 652, compute instances having an instance feature of a single database and corresponding to the compute task are identified and recommended for the compute task. Recommendation and allocation of cross-database compute instances are prevented or prohibited.

At 654, the compute task is determined to be a non-production task associated with an in-memory caching service (e.g., ElastiCache of AWS) on the cloud platform. At 656, cache node compute instances with a node type of T-type and a total number of no more than three are recommended for the compute task and allocated to the user. Recommendation and allocation of other cache nodes with a different type (e.g., higher unit price) and a total number of three are prevented or prohibited.

It should be noted that logic illustrated in FIGS. 6C is for illustrative purposes only, and other logics for optimizing the total cost of compute instance based on preestablished rules and cost policies are also possible in alternative implementations within the scope of the present disclosure.

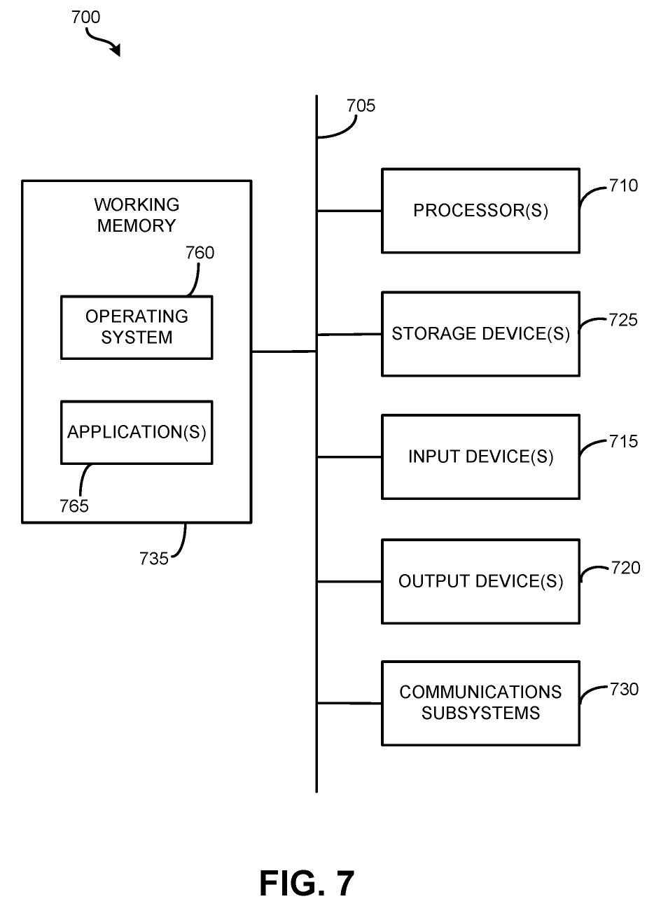

The communications system 300 and any components thereof, such as the customer account management system 130, the cost analysis module 142, the cloud management system 120, etc., described above may include a computer system that further includes computer hardware and software that form special-purpose network circuitry to implement various embodiments such as communication, generation and collection of data, analysis, determination, identification, calculation, performing a task, execution of a service or application, and other operations or steps of the methods or processes described herein. FIG. 7 is a schematic diagram illustrating an example of computer system 700. The computer system 700 is a simplified computer system that can be used to implement various embodiments described and illustrated herein. FIG. 7 provides a schematic illustration of one embodiment of a computer system 700 that can perform some or all of the steps of the methods and workflows provided by various embodiments. It should be noted that FIG. 7 is meant only to provide a generalized illustration of various components, any or all of which may be utilized as appropriate. FIG. 7, therefore, broadly illustrates how individual system elements may be implemented in a relatively separated or relatively more integrated manner.

The computer system 700 is shown including hardware elements that can be electrically coupled via a bus 705, or may otherwise be in communication, as appropriate. The hardware elements may include one or more processors 710, including without limitation one or more general-purpose processors and/or one or more special-purpose processors such as digital signal processing chips, graphics acceleration processors, and/or the like; one or more input devices 715, which can include without limitation a mouse, a keyboard, a camera, and/or the like; and one or more output devices 720, which can include without limitation a display device, a printer, and/or the like.

The computer system 700 may further include and/or be in communication with one or more non-transitory storage devices 725, which can include, without limitation, local and/or network accessible storage, and/or can include, without limitation, a disk drive, a drive array, an optical storage device, a solid-state storage device, such as a random access memory ("RAM"), and/or a read-only memory ("ROM"), which can be programmable, flash-updateable, and/or the like. Such storage devices may be configured to implement any appropriate data stores, including without limitation, various file systems, database structures, and/or the like.

The computer system 700 might also include a communications subsystem 730, which can include without limitation a modem, a network card (wireless or wired), an infrared communication device, a wireless communication device, and/or a chipset such as a Bluetooth™ device, an 802.11 device, a WiFi device, a WiMax device, cellular communication facilities, etc., and/or the like. The communications subsystem 730 may include one or more input and/or output communication interfaces to permit data to be exchanged with a network such as the network described below to name one example, other computer systems, television, and/or any other devices described herein. Depending on the desired functionality and/or other implementation concerns, a portable electronic device or similar device may communicate image and/or other information via the communications subsystem 730. In other embodiments, a portable electronic device, e.g., the first electronic device, may be incorporated into the computer system 700, e.g., an electronic device as an input device 715. In some embodiments, the computer system 700 will further include a working memory 735, which can include a RAM or ROM device, as described above.

The computer system 700 also can include software elements, shown as being currently located within the working memory 735, including an operating system 760, device drivers, executable libraries, and/or other code, such as one or more application programs 765, which may include computer programs provided by various embodiments, and/or may be designed to implement methods, and/or configure systems, provided by other embodiments, as described herein. Merely by way of example, one or more procedures described with respect to the methods discussed above, such as those described in relation to FIG. 7, might be implemented as code and/or instructions executable by a computer and/or a processor within a computer; in an aspect, then, such code and/or instructions can be used to configure and/or adapt a general purpose computer or other device to perform one or more operations in accordance with the described methods.

A set of these instructions and/or code may be stored on a non-transitory computer-readable storage medium, such as the storage device(s) 725 described above. In some cases, the storage medium might be incorporated within a computer system, such as computer system 700. In other embodiments, the storage medium might be separate from a computer system e.g., a removable medium, such as a compact disc, and/or provided in an installation package, such that the storage medium can be used to program, configure, and/or adapt a general-purpose computer with the instructions/code stored thereon. These instructions might take the form of executable code, which is executable by the computer system 700 and/or might take the form of source and/or installable code, which, upon compilation and/or installation on the computer system 700 e.g., using any of a variety of generally available compilers, installation programs, compression/decompression utilities, etc., then takes the form of executable code.

It will be apparent that substantial variations may be made in accordance with specific requirements. For example, customized hardware might also be used, and/or particular elements might be implemented in hardware, software including portable software, such as applets, etc., or both. Further, connection to other computing devices such as network input/output devices may be employed.

As mentioned above, in one aspect, some embodiments may employ a computer system such as the computer system 700 to perform methods in accordance with various embodiments of the technology. According to a set of embodiments, some or all of the operations of such methods are performed by the computer system 700 in response to processor 710 executing one or more sequences of one or more instructions, which might be incorporated into the operating system 760 and/or other code, such as an application program 765, contained in the working memory 735. Such instructions may be read into the working memory 735 from another computer-readable medium, such as one or more of the storage device(s) 725. Merely by way of example, execution of the sequences of instructions contained in the working memory 735 might cause the processor(s) 710 to perform one or more procedures of the methods described herein. Additionally or alternatively, portions of the methods described herein may be executed through specialized hardware.

The terms "machine-readable medium" and "computer-readable medium," as used herein, refer to any medium that participates in providing data that causes a machine to operate in a specific fashion. In an embodiment implemented using the computer system 700, various computer-readable media might be involved in providing instructions/code to processor(s) 710 for execution and/or might be used to store and/or carry such instructions/code. In many implementations, a computer-readable medium is a physical and/or tangible storage medium. Such a medium may take the form of a non-volatile media or volatile media. Non-volatile media include, for example, optical and/or magnetic disks, such as the storage device(s) 725. Volatile media include, without limitation, dynamic memory, such as the working memory 735.

Common forms of physical and/or tangible computer-readable media include, for example, a floppy disk, a flexible disk, hard disk, magnetic tape, or any other magnetic medium, a CD-ROM, any other optical medium, punchcards, papertape, any other physical medium with patterns of holes, a RAM, a PROM, EPROM, a FLASH-EPROM, any other memory chip or cartridge, or any other medium from which a computer can read instructions and/or code.

Various forms of computer-readable media may be involved in carrying one or more sequences of one or more instructions to the processor(s) 710 for execution. Merely by way of example, the instructions may initially be carried on a magnetic disk and/or optical disc of a remote computer. A remote computer might load the instructions into its dynamic memory and send the instructions as signals over a transmission medium to be received and/or executed by the computer system 700.

The communications subsystem 730 and/or components thereof generally will receive signals, and the bus 705 then might carry the signals and/or the data, instructions, etc. carried by the signals to the working memory 735, from which the processor(s) 710 retrieves and executes the instructions. The instructions received by the working memory 735 may optionally be stored on a non-transitory storage device 725 either before or after execution by the processor(s) 710.

The methods, process, systems, and devices discussed above are examples. Various configurations may omit, substitute, or add various procedures or components as appropriate. For instance, in alternative configurations, the methods may be performed in an order different from that described, and/or various stages may be added, omitted, and/or combined. Also, features described with respect to certain configurations may be combined in various other configurations. Various aspects and elements of the configurations may be combined in a similar manner. Also, technology evolves and, thus, many of the elements are examples and do not limit the scope of the disclosure or claims.

Specific details are given in the description to provide a thorough understanding of exemplary configurations including implementations. However, configurations may be practiced without these specific details. For example, well-known circuits, processes, algorithms, structures, and techniques have been shown without unnecessary detail in order to avoid obscuring the configurations. This description provides example configurations only, and does not limit the scope, applicability, or configurations of the claims. Rather, the preceding description of the configurations will provide an enabling description for implementing described techniques. Various changes may be made in the function and arrangement of elements without departing from the spirit or scope of the disclosure.

Also, configurations may be described as a process which is depicted as a schematic flowchart or block diagram. Although each may describe the operations as a sequential process, many of the operations can be performed in parallel or concurrently. In addition, the order of the operations may be rearranged. A process may have additional steps not included in the figure. Furthermore, examples of the methods may be implemented by hardware, software, firmware, middleware, microcode, hardware description languages, or any combination thereof. When implemented in software, firmware, middleware, or microcode, the program code or code segments to perform the necessary tasks may be stored in a non-transitory computer-readable medium such as a storage medium. Processors may perform the described tasks.

As used herein and in the appended claims, the singular forms "a", "an", and "the" include plural references unless the context clearly dictates otherwise. Thus, for example, reference to "an instance" includes a plurality of such instances, and reference to "the processor" includes reference to one or more processors and equivalents thereof known in the art, and so forth.

Also, the words "comprise", "comprising", "contains", "containing", "include", "including", and "includes", when used in this specification and in the following claims, are intended to specify the presence of stated features, integers, components, or steps, but they do not preclude the presence or addition of one or more other features, integers, components, steps, acts, or groups.

As used herein, a "compute instance" used interchangeably with "compute resource," "virtual machine," "node," and "instance," refers to a virtualized computing environment that is provisioned by a cloud provider. A compute instance consists of virtualized hardware resources such as CPU, memory, storage, and networking, which are allocated to the user for executing applications, workloads, or services. Compute instances can be rapidly deployed, configured, and managed through management and orchestration component of the cloud computing platform. Compute instances are commonly used to host various types of workloads, including web applications, databases, batch processing jobs, machine learning (ML) models, and more.

As used herein, an "on-demand instance" refers to a type of compute instance without the need for any long-term commitment or upfront payment. Users can request on-demand instances as needed, and they are billed for the actual usage duration, typically on an hourly or per-second basis. On-demand instances provide flexibility and scalability to allow users to scale resources up or down dynamically based on workload requirements without prior reservation.

As used herein, a "spot instance" refers to a type of compute instance at significantly discounted prices compared to on-demand instances. However, spot instances are subject to availability and can be terminated by the cloud provider when demand for resources increases. Users bid for spot instances, specifying the maximum price they are willing to pay per hour. The cloud provider may allocate spot instances to users based on their bids and the available capacity.

As used herein, a "customer" refers to an entity, organization, or individual that subscribes to cloud computing services provided by a cloud provider. Customers utilize cloud services to host applications, store data, and perform various computing tasks. Customers may include businesses, enterprises, government agencies, educational institutions, and individual users.

As used herein, an "account," also known as a "customer account" or "subscription account," is a unique identifier associated with a customer of the cloud provider within the cloud computing platform. Each customer may have one master account registered with the cloud provider and optionally one or more subsidiary accounts within the master account. The account is used by the administrator of the customer to access and manage cloud services and resource allocation. Within each account, users may have different roles and permissions granted by the account owner or administrator.

As used herein, "instances committed to a customer," also known as "customer-specific instances" or "account-specific instances," refer to a specific allocation of compute resources that are dedicated to a particular customer or account within a cloud computing environment. The instances committed to a customer may be provisioned based on contractual agreements or commitments between the cloud provider and the customer at a discounted price and are reserved exclusively for the customer's use and are not shared with other customers or users of the cloud computing platform.

As used herein, a "user" or internal user refer to an individual or entity that is a part of the customer that owns and manages the account within a cloud platform. Users interact with the cloud computing platform to perform various computing tasks, access resources, and utilize services through the account.

Having described several example configurations, various modifications, alternative constructions, and equivalents may be used without departing from the spirit of the disclosure. For example, the above elements may be components of a larger system, wherein other rules may take precedence over or otherwise modify the application of the invention. Also, a number of steps may be undertaken before, during, or after the above elements are considered.

What is claimed is:

1. A method performed by a customer account management system of a customer account associated with a cloud computing platform, the method comprising:
receiving a request for performing a compute task on the cloud computing platform, from a user associated with the customer account;
identifying a predetermined class for the compute task based on one or more features of the compute task;
identifying one or more classes of compute instances correlating to the compute task, based on a predetermined correlation rule; and
performing a cost optimization process to determine one or more compute instances from one class of the identified classes for the requested compute task, wherein the cost optimization process further comprises:
determining a total number of the compute instances from each one of the classes for performing the compute task;
anticipating a time duration of executing the one or more compute instances from each one of the classes for performing the compute task;
calculating, for each one of the classes, a total cost for the one or more compute instances of the class, based on the total number of the compute instances, the time duration, and a predetermined unit price for the compute instance; and
ranking the one or more classes of compute instances, based on the total costs for each class.

2. The method of claim 1, further comprising:
determining availability of the total number of compute instances of each class on the cloud computing platform.

3. The method of claim 2, further comprising:
selecting the class of the total number of instances having the lowest total cost; and
determining a specific time of allocating the compute instances of the selected class.

4. The method of claim 3, further comprising:
generating an output, the output recommending the class of the compute instances having the lowest total cost, the total number of the compute instances, and the specific time of allocating the compute instances to a decision maker of the customer;
upon receiving an approval from the decision maker, sending a request for allocating the compute instances to the cloud computing platform; and
causing the compute instances to be allocated to a cloud specific to the user on the cloud computing platform at the specific time.

5. The method of claim 2, wherein determining the availability of the compute instances further comprises:
obtaining real-time usage data indicating a current usage of the compute instances of each one of the classes on the cloud computing platform; and
determining whether the compute instances with the lowest cost are currently available, based on the real-time usage data and a total number of the compute instances of the class.

6. The method of claim 2, wherein determining the availability of the compute instances further comprises:
estimating the usage of compute instances of each one of the classes for an anticipated time duration of executing the one or more compute instances; and
determining whether the compute instances with the lowest cost are available during the anticipated time duration, based on the estimated usage and a total number of the compute instances of the class.

7. The method of claim 2, wherein the class for the compute task is not a predetermined high-priority class, and the class of compute instances with the lowest cost is a class of on-demand compute instances specific to the customer.

8. The method of claim 3, wherein the predetermined class for the compute task is not a high-priority class, and the specific time of allocating the compute instances is in a predetermined off-peak period.

9. The method of claim 1, wherein the one or more features of the requested compute task indicate that the compute task is to be performed in a non-production cloud environment on the cloud computing platform, and the class of the compute instances with the lowest cost has an instance type of a single database compute instance.

10. The method of claim 1, wherein the one or more features of the requested compute task indicates that the compute task is to be performed in a specific availability zone (AZ) of the cloud computing platform, and the class of the compute instances with the lowest cost is specific to the AZ.

11. The method of claim 10, further comprising:
refraining from recommending a cross-AZ compute instance for the requested compute task.

12. A customer account management system of a customer account associated with a cloud computing platform, the customer account management system comprising:
one or more processors; and
a computer-readable storage media storing computer-executable instructions, wherein the instructions, when executed by the one or more processors, cause the customer account management system to:
receive a request for performing a compute task on the cloud computing platform, from a user associated with the customer account;
identify a predetermined class for the compute task based on one or more features of the compute task;
identify one or more classes of compute instances correlating to the compute task, based on a predetermined correlation rule; and
perform a cost optimization process to determine one or more compute instances from one class of the identified classes for the requested compute task, wherein the cost optimization process further comprises:
determining a total number of the compute instances from each one of the classes for performing the compute task;
anticipating a time duration of executing the one or more compute instances from each one of the classes for performing the compute task;
calculating, for each one of the classes, a total cost for the one or more compute instances of the class, based on the total number of the compute instances, the time duration, and a predetermined unit price for the compute instance; and
ranking the one or more classes of compute instances, based on the total costs for each class.

13. The customer account management system of claim 12, wherein the instructions when executed by the one or more processors further cause the customer account management system to:
determine availability of the total number of compute instances of each class on the cloud computing platform.

14. The customer account management system of claim 13, wherein the instructions when executed by the one or more processors further cause the customer account management system to:
select the class of the total number of instances having the lowest total cost; and
determine a specific time of allocating the compute instances of the selected class.

15. The customer account management system of claim 14, wherein the instructions when executed by the one or more processors further cause the customer account management system to:
generate an output, the output recommending the class of the compute instances having the lowest total cost, the total number of the compute instances, and the specific time of allocating the compute instances to a decision maker of the customer;
upon receiving an approval from the decision maker, send a request for allocating the compute instances to the cloud computing platform; and
cause the compute instances to be allocated to a cloud specific to the user on the cloud computing platform at the specific time.

16. The customer account management system of claim 13, wherein the instructions when executed by the one or more processors further cause the customer account management system to:
obtain real-time usage data indicating a current usage of the compute instances of each one of the classes on the cloud computing platform; and
determine whether the compute instances with the lowest cost are currently available, based on the real-time usage data and a total number of the compute instances of the class.

17. The customer account management system of claim 13, wherein the instructions when executed by the one or more processors further cause the customer account management system to:
estimate the usage of compute instances of each one of the classes for an anticipated time duration of executing the one or more compute instances; and
determine whether the compute instances with the lowest cost are available during the anticipated time duration, based on the estimated usage and a total number of the compute instances of the class.

18. The customer account management system of claim 13, wherein the class for the compute task is not a high-priority class, and the class of compute instances with the lowest cost is a class of on-demand compute instances specific to the customer.

19. The customer account management system of claim 14, wherein the predetermined class for the compute task is not a high-priority class, and the specific time of allocating the compute instances is in a predetermined off-peak period.

20. The customer account management system of claim 12, wherein the one or more features of the requested compute task indicate that the compute task is to be performed in a non-production cloud environment on the cloud computing platform, and the class of the compute instances with the lowest cost has an instance type of a single database compute instance.
